(19) United States
(12) Patent Application Publication
(10) Pub. No.: US 2010/0254334 A1
(43) Pub. Date: Oct. 7, 2010

(54) SETTING UP A COMMUNICATION SESSION WITHIN A WIRELESS COMMUNICATIONS SYSTEM

(75) Inventors: YIH-HAO LIN, San Diego, CA (US); Bongyong Song, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/751,582

(22) Filed: Mar. 31, 2010

Related U.S. Application Data
(60) Provisional application No. 61/167,081, filed on Apr. 6, 2009.

(51) Int. Cl. H04W 72/04

(52) U.S. Cl. 370/329; 455/450

(57) ABSTRACT

Aspects disclosed embodiments include methods, apparatuses and systems for setting up a communication session within a wireless communications system. In an embodiment, a determination is made as to whether one or more applications or services are supported by an access terminal for the communication session. Session resources are then allocated to the access terminal in support of the communication session to the access terminal based at least in part upon the determination.

The present application for patent claims priority to Provisional Application No. 61/167,081 entitled “SETTING UP A COMMUNICATION SESSION WITHIN A WIRELESS COMMUNICATIONS SYSTEM” filed Apr. 6, 2009, and assigned to the assignee hereof and hereby expressly incorporated by reference herein.

### BACKGROUND OF THE INVENTION

1. Field of the Invention

Embodiments of the invention relate to setting up a communication session within a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as CDMA, FDMA, TDMA, GSM, etc. In a dispatch model, communication between endpoints (ATs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

Conventionally, data packets within a wireless communications network have been configured to be sent to a single destination or access terminal. A transmission of data to a single destination is referred to as “unicast”. As mobile communications have increased, the ability to transmit given data concurrently to multiple access terminals has become more important. Accordingly, protocols have been adopted to support concurrent data transmissions of the same packet or message to multiple destinations or target access terminals. A “broadcast” refers to a transmission of data packets to all destinations or access terminals (e.g., within a given cell, served by a given service provider, etc.), while a “multicast” refers to a transmission of data packets to a given group of destinations or access terminals. In an example, the given group of destinations or “multicast group” may include more than one and less than all of possible destinations or access terminals (e.g., within a given group, served by a given service provider, etc.). However, it is at least possible in certain situations that the multicast group comprises only one access terminal, similar to a unicast, or alternatively that the multicast group comprises all access terminals (e.g., within a cell or sector), similar to a broadcast.

Broadcasts and/or multicasts may be performed within wireless communication systems in a number of ways, such as performing a plurality of sequential unicast operations to accommodate the multicast group, allocating a unique broadcast/multicast channel (BCH) for handling multiple data transmissions at the same time and the like. A conventional system using a broadcast channel for push-to-talk communications is described in United States Patent Application Publication No. 2007/0049314 dated Mar. 1, 2007 and entitled “Push-To-Talk Group Call System Using CDMA 1x-EVDO Cellular Network”, the contents of which are incorporated herein by reference in its entirety. As described in Publication No. 2007/0049314, a broadcast channel can be used for push-to-talk calls using conventional signaling techniques. Although the use of a broadcast channel may improve bandwidth requirements over conventional unicast techniques, the conventional signaling of the broadcast channel can still result in additional overhead and/or delay and may degrade system performance.

The 3^{rd} Generation Partnership Project 2 (“3GPP2”) defines a broadcast-multicast service (BCMCS) specification for supporting multicast communications in CDMA2000 networks. Accordingly, a version of 3GPP2's BCMCS specification, entitled “CDMA2000 High Rate Broadcast-Multicast Packet Data Air Interface Specification”, dated Feb. 14, 2006, Version 1.0 C.S0054-A, is hereby incorporated by reference in its entirety.

### SUMMARY

Aspects of the invention include methods, apparatuses and systems for setting up a communication session within a wireless communications system. In an embodiment, a determination is made as to whether one or more applications or services are supported by an access terminal for the communication session. Session resources are then allocated to the access terminal in support of the communication session to the access terminal based at least in part upon the determination.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates the carrier network according to an example embodiment of the present invention.

FIG. 3 is an illustration of an access terminal in accordance with at least one embodiment of the invention.

FIG. 4 illustrates a conventional packet data protocol (PDP) context activation and resource allocation for a General Packet Radio Services (GPRS) communication session.

FIG. 5 illustrates PDP context activation and resource allocated for a GPRS communication session according to an embodiment.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or packet control function (PCF). Modem pool transceivers and modem pool controllers are parts of a network called an access network. An access network transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

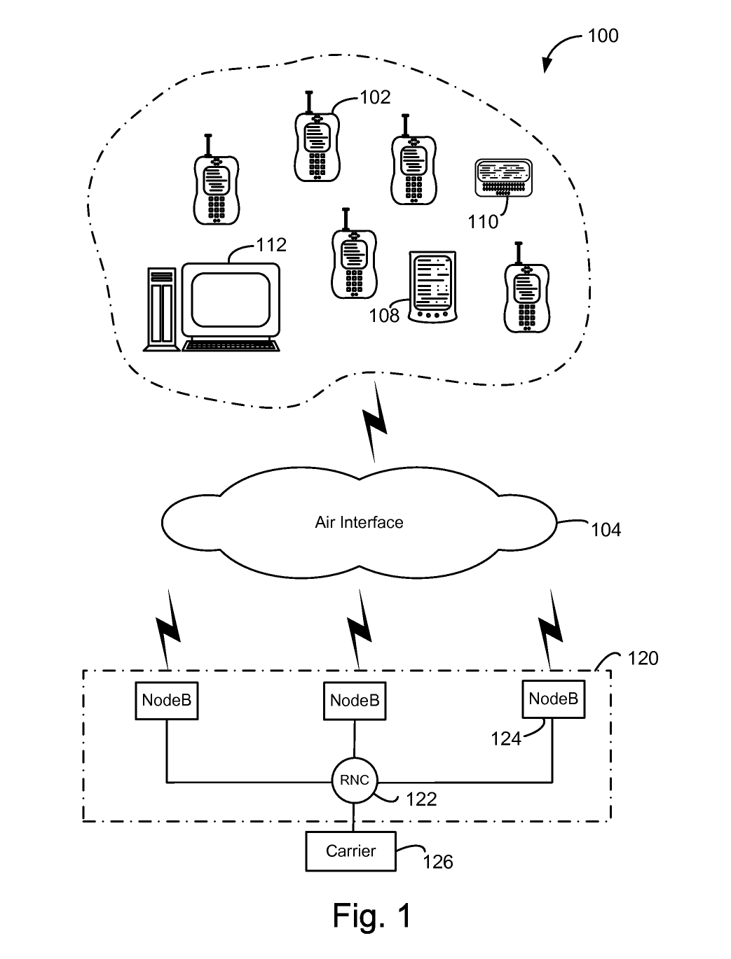

FIG. 1 illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a Radio Network Controller (RNC) 122. The RNC 122 is responsible for signaling, establishing, and tearing down bearer channels (i.e., data channels) between a Serving General Packet Radio Services (GPRS) Support Node (SGSN) 160 and the access terminals 102/108/110/112. If link layer encryption is enabled, the RNC 122 also encrypts the content before forwarding it over the air interface 104. The function of the RNC 122 is well-known in the art and will not be discussed further for the sake of brevity. The carrier network 126 may communicate with the RNC 122 by a network, the Internet and/or a public switched telephone network (PSTN). Alternatively, the RNC 122 may connect directly to the Internet or external network. Typically, the network or Internet connection between the carrier network 126 and the RNC 122 transfers data, and the PSTN transfers voice information. The RNC 122 can be connected to multiple base stations (NodeB) 124. In a similar manner to the carrier network, the RNC 122 is typically connected to the NodeB 124 by a network, the Internet and/or PSTN for data transfer and/or voice information. The NodeB 124 can broadcast data messages wirelessly to the access terminals, such as cellular telephone 102. The NodeB 124, RNC 122 and other components may form the RAN 120, as is known in the art. However, alternate configurations may also be used and the invention is not limited to the configuration illustrated. For example, in another embodiment the functionality of the RNC 122 and one or more of the NodeB 124 may be collapsed into a single “hybrid” module having the functionality of both the RNC 122 and the NodeB 124.

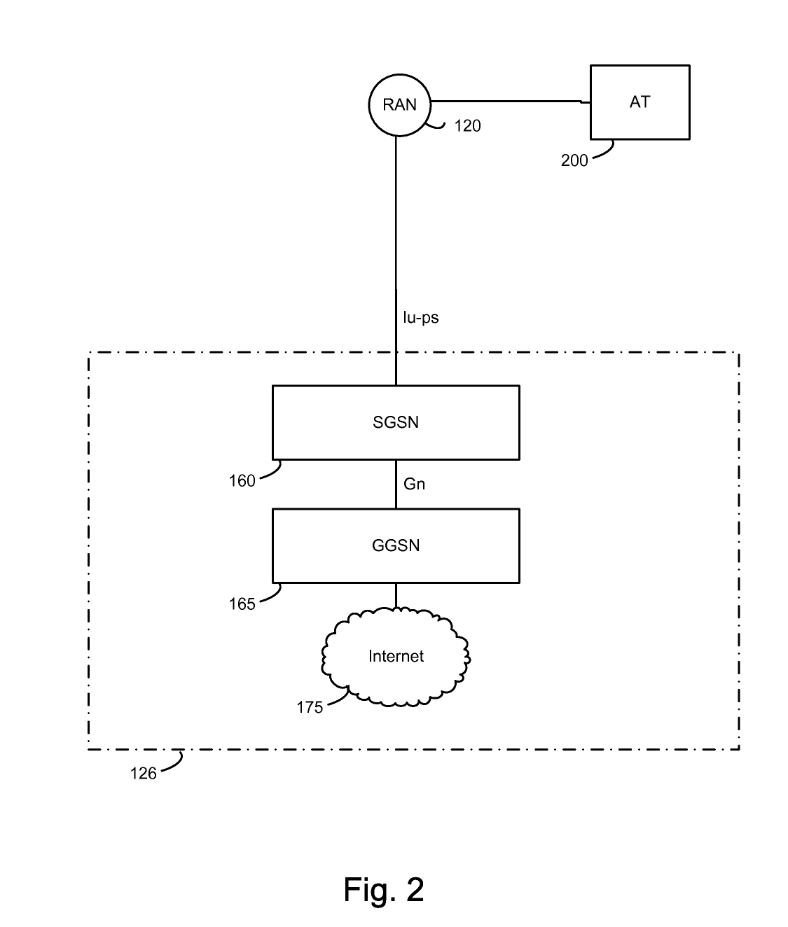

FIG. 2 illustrates the carrier network 126 according to an embodiment of the present invention. In particular, the carrier network 126 illustrates components of a General Packet Radio Services (GPRS) core network. In the embodiment of FIG. 2, the carrier network 126 includes a Serving GPRS Support Node (SGSN) 160, a Gateway GPRS Support Node (GGSN) 165 and an Internet 175. However, it is appreciated that portions of the Internet 175 and/or other components may be located outside the carrier network in alternative embodiments.

Generally, GPRS is a protocol used by Global System for Mobile communications (GSM) phones for transmitting Internet Protocol (IP) packets. The GPRS Core Network (e.g., the GGSN 165 and one or more SGSNs 160) is the centralized part of the GPRS system and also provides support for W-CDMA based 3G networks. The GPRS core network is an integrated part of the GSM core network, provides mobility management, session management and transport for IP packet services in GSM and W-CDMA networks.

The GPRS Tunneling Protocol (GTP) is the defining IP protocol of the GPRS core network. The GTP is the protocol which allows end users (e.g., access terminals) of a GSM or W-CDMA network to move from place to place while continuing to connect to the internet as if from one location at the GGSN 165. This is achieved transferring the subscriber's data from the subscriber's current SSGN 160 to the GGSN 165, which is handling the subscriber's session.

Three forms of GTP are used by the GPRS core network; namely, (i) GTP-U, (ii) GTP-C and (iii) GTP' (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP' is used for transfer of charging data from GSNs to a charging function.

Referring to FIG. 2, the GGSN 165 acts as an interface between the GPRS backbone network (not shown) and the external packet data network 175. The GGSN 165 extracts the packet data with associated packet data protocol (PDP) format (e.g., IP or PPP) from the GPRS packets coming from the SGSN 160, and sends the packets out on a corresponding packet data network. In the other direction, the incoming data packets are directed by the GGSN 165 to the SGSN 160 which manages and controls the Radio Access Bearer (RAB) of the destination AT served by the RAN 120. Thereby, the GGSN 165 stores the current SGSN address of the target AT and his/her profile in its location register (e.g., within a PDP context). The GGSN is responsible for IP address assignment and is the default router for the connected AT. The GGSN also performs authentication and charging functions.

The SGSN 160 is representative of one of many SGSNs within the carrier network 126, in an example. Each SGSN is responsible for the delivery of data packets from and to the mobile stations or ATs within an associated geographical service area. The tasks of the SGSN 160 include packet routing and transfer, mobility management (e.g., attach/detach and location management), logical link management, and authentication and charging functions. The location register of the SGSN stores location information (e.g., current cell, current VLR) and user profiles (e.g., IMSI, PDP address(es) used in the packet data network) of all GPRS users registered with the SGSN 160, for example, within one or more PDP contexts for each user or AT. Thus, SGSNs are responsible for (i) de-tunneling downlink GTP packets from the GGSN 165, (ii) uplink tunnel IP packets toward the GGSN 165, (iii) carrying out mobility management as ATs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in Universal Mobile Telecommunications System (UMTS) system architecture) communicates with the SGSN 160 via an Iu interface, with a transmission protocol such as Frame Relay or IP. The SGSN 160 communicates with the GGSN 165 via a Gn interface, which is an IP-based interface between SGSN 160 and other SGSNs (not shown) and internal GGSNs, and uses the GTP protocol defined above (e.g., GTP-U, GTP-C, GTP', etc.). While not shown in FIG. 2, the Gn interface is also used by the Domain Name System (DNS). The GGSN 165 is connected to a Public Data Network (PDN) (not shown), and in turn to the Internet 175, via a Gi interface with IP protocols either directly or through a Wireless Application Protocol (WAP) gateway.

The PDP context is a data structure present on both the SGSN 160 and the GGSN 165 which contains a particular AT's communication session information when the AT has an active GPRS session. When an AT wishes to initiate a GPRS communication session, the AT must first attach to the SGSN 160 and then activate a PDP context with the GGSN 165. This allocates a PDP context data structure in the SGSN 160 that the subscriber is currently visiting and the GGSN 165 serving the AT's access point.

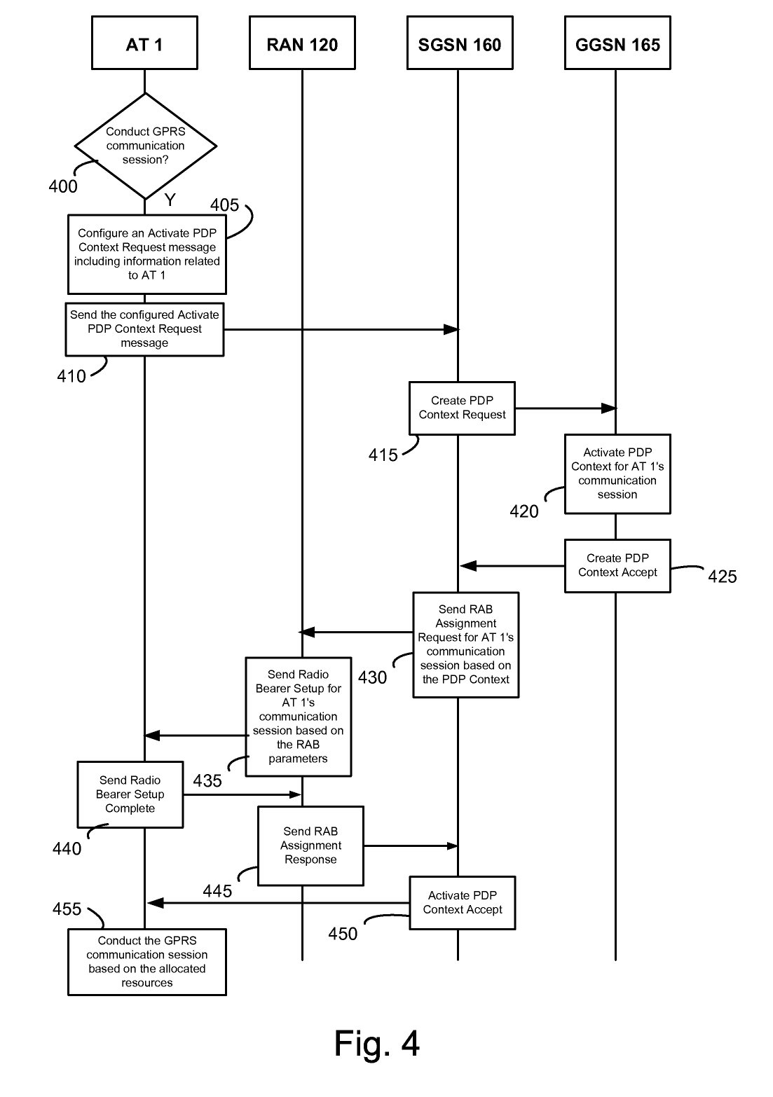

For example, the PDP context can include (i) PDP parameters, (ii) identifiers, (iii) PDP context-type and (iv) one or more other fields. For example, the (i) PDP parameters may include ToS, Access Point Name (APN), Quality of Service (QoS) for the communication session, the AT's IP address, etc.). The (ii) identifiers may include the AT's International Mobile Subscriber Identity (IMSI), Network Service Access Point Identifier (NSAPI), or tunnel endpoint ID (TEID) (i.e., the TEID is a number allocated by the SGSN and/or GSN that identifies tunneled data related to a particular PDP context) at the SGSN 160 and/or the GSGN 165. With regard to (iii) PDP context-type, it is appreciated that there are generally two types of PDP contexts (i.e., primary and secondary) which can be indicated by this field. For example, the primary PDP context includes a unique IP address, whereas the secondary PDP context shares an IP address with at least one other PDP context, is created by an existing PDP context (i.e., so as to share its IP address) and each secondary PDP context may have a different QoS setting from another PDP context associated with the same AT. In an example, up to 11 PDP contexts (e.g., with any combination of Primary and Secondary) can co-exist for a particular AT. An example of how PDP contexts are conventionally activated will be given below with respect to FIG. 4.

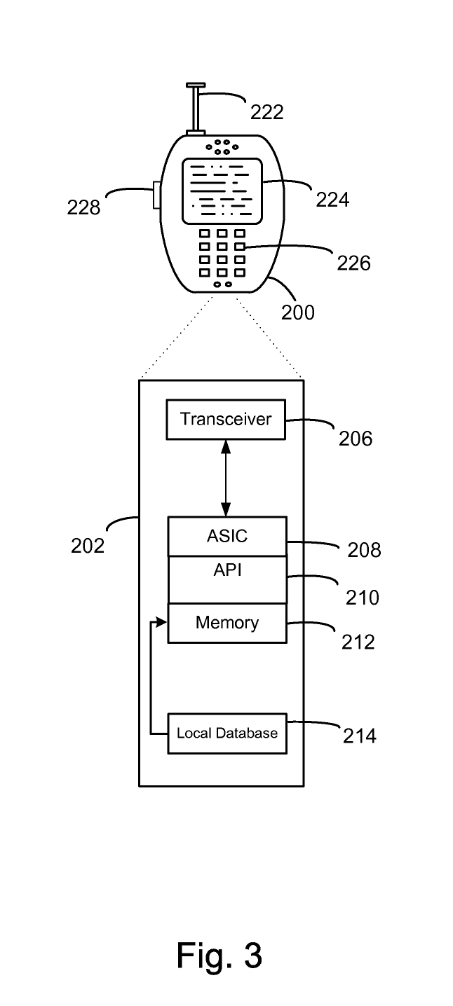

Referring to FIG. 3, an access terminal 200, (here a wireless device), such as a cellular telephone, has a platform 202 that can receive and execute software applications, data and/or commands transmitted from the RAN 120 that may ultimately come from the carrier network 126, the Internet 175 and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3 are to be considered merely illustrative and the invention is not limited to the illustrated features or arrangement.

The wireless communication between the access terminal 102 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. The data communication is typically between the client device 102, NodeB 124, and RNC 122. The RNC 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the RAN using a variety of networks and configurations. Accordingly, the illustrations provided herein are not intended to limit the embodiments of the invention and are merely to aid in the description of aspects of embodiments of the invention.

FIG. 4 illustrates a conventional process for setting up a given GPRS communication session. In particular, FIG. 4 illustrates a conventional manner of activating a PDP context for the given GPRS communication session, as well as allocating resources to an AT for supporting the given GPRS communication session based on the activated PDP context.

Referring to FIG. 4, AT 1 determines whether to conduct a GPRS communication session, 400. For example, the determination of 400 may correspond to the startup of a push-to-talk (PTT) application on AT 1 if the GPRS communication session corresponds to a group PTT call (e.g., a multicast call, etc.). If AT 1 determines to conduct a GPRS communication session, AT 1 is required to activate a PDP context for the session. Thus, AT 1 configures an Activate PDP Context Request message that includes information related to AT 1 for the GPRS communication session, 405. For example, the Activate PDP Context Request message may be configured to include the Requested QoS for the session, an access point number (APN) of the GGSN 165 (e.g., which may be obtained after a DNS query), etc. If the PDP Address, to which packets are addressed during the GPRS communication session, is dynamically assigned by the GGSN, in the Activate PDP Context Request message, the PDP Address field is empty because the PDP context for AT 1's session has not yet been activated.

After configuring the Activate PDP Context Request message in 405, AT 1 sends the configured Activate PDP Request message to the SGSN 160 via the RAN 120, 410. The SGSN 160 receives the Activate PDP Context Request message and sends a Create PDP Context Request message to the GGSN 165, 415. The GGSN 165 receives the Create PDP Context Request message from the SGSN 160, and activates a PDP context for AT 1's communication session, 420. The activation of the PDP context in 420 includes assigning a PDP address for AT 1's communication session (e.g., an IPv6 address). The GGSN 165 sends a Create PDP Context Accept message back to the SGSN 160, 425, which indicates that the Create PDP Context Request message from 415 is accepted and also conveys the PDP address for AT 1's communication session. The SGSN 160 sends a RAB assignment request for AT 1's communication session based on the PDP context to the RAN 120, 430. For example, the SGSN 160 may instruct the RAN 120 with regard to a given level of QoS resources for allocating to AT 1 during the communication session using the RAB Parameter field in the RAB Assignment Request, which contains the QoS requirements on AT 1's communication link. The RAN 120 receives the RAB assignment request and sends a Radio Bearer Setup message for AT 1's communication session based on the RAB parameters, 435. AT 1 receives the Radio Bearer Setup message, configures the Radio Bearer accordingly, and sends a Radio Bearer Setup Complete message to the RAN 120, 440. The RAN 120 then sends a RAB Assignment Response message back to the SGSN 160, 445. At this point, the SGSN 160 sends an Activate PDP Context Accept message to AT 1 via the RAN 120, 450, which indicates that the Activate PDP Context Request message from 410 is accepted and also conveys the PDP address for AT 1's communication session.

After receiving the Activate PDP Context Accept message in 450 (e.g., which conveys the PDP address to be used for the session), AT 1 may begin to send and receive messages related to the established communication session, 455.

As will be appreciated by one of ordinary skill in the art, while the PDP context can indicate the PDP-type (e.g., primary or secondary), PDP parameters (e.g., ToS, APN, QoS, PDP address, etc.), identifiers (e.g., NSAPI, TI, TEID, etc.) and/or other parameters, conventional PDP contexts do not include information related to the application or service associated with the GPRS communication session being activated and are supported by AT 1. For example, if the GPRS communication session corresponds to the signaling of a PTT call that AT 1 wishes to initiate or join, the signaling of PTT call is a delay-sensitive interactive application. However, the SGSN 160 and GGSN 165 may recognize that the application is an originating interactive call but do not necessarily have special knowledge with regard to the nature of the application, and as such do not know that the session is delay or time-sensitive. Thus, the SGSN 160 and GGSN 165 do not necessarily grant aggressive resources to AT 1, which can degrade performance for AT 1's communication session.

Embodiments which will be described below in more detail are directed to conveying application or service-specific information from an AT requesting PDP context activation to the RAN 120, SGSN 160 and/or GGSN 165, and storing the conveyed application or service-specific information in the PDP context. The RAN 120, SGSN 160 and/or GGSN 165 may then allocate resources to the requesting AT for the communication session based at least in part on the application or service-specific information.

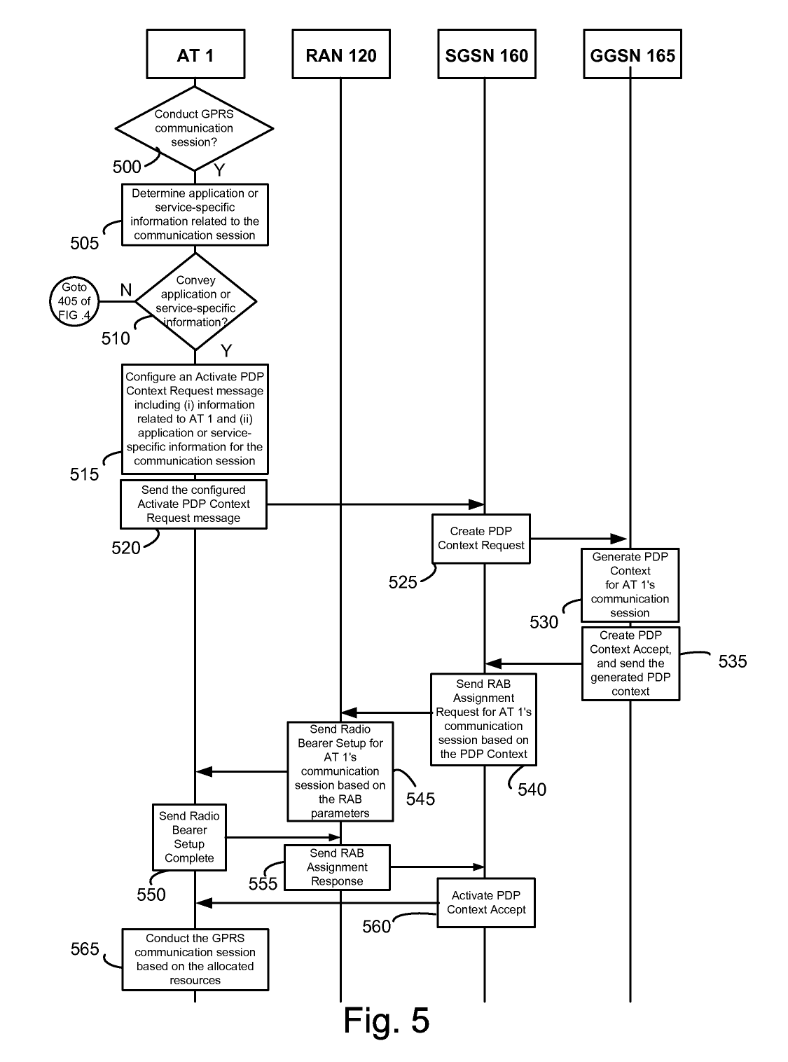

Accordingly, FIG. 5 illustrates a process for setting up a given GPRS communication session according to an embodiment of the invention. In particular, FIG. 5 illustrates a manner of activating a PDP context for the given GPRS communication session that is configured to include application or service-specific information related to the session, as well as allocating resources to an AT for supporting the given GPRS communication session based on the activated PDP context.

Referring to FIG. 5, AT 1 determines whether to conduct a GPRS communication session, 500. For example, the determination of 500 may correspond to a user of AT 1 pressing a push-to-talk (PTT) button on AT 1 if the GPRS communication session corresponds to a group PTT call (e.g., a multicast call, etc.). After determining to conduct the GPRS communication session in 500, AT 1 determines, if possible, application or service-specific information related to the communication session, 505. As used herein, application or service-specific information is defined as any information related to a service or application supported by AT 1 and associated with the communication session. With regard to the group PTT call example, the application or service-specific information may correspond to a recognition that the communication session is for a group or PTT call.

In 510, AT 1 determines whether to convey the application or service-specific information determined in 505 to the SGSN 160 and/or the GGSN 165. For example, if an application associated with the GPRS communication session is not delay-sensitive, then AT 1 may determine not to send application-specific information in 510, and the process may advance to 405 of FIG. 4, as described above. Otherwise, if AT 1 determines to convey the application or service-specific information determined in 505 to the SGSN 160 and/or the GGSN 165 (e.g., if an application associated with the GPRS communication session is delay-sensitive, etc.), then the process advances to 515.

In 515, AT 1 configures an Activate PDP Context Request message that includes information related to AT 1 for the GPRS communication session, similar to 405 of FIG. 4. For example, the Activate PDP Context Request message may be configured to include AT 1's an access point name (APN) of the GGSN 165 (e.g., which may be obtained after a DNS query), etc. In the Activate PDP Context Request message, the PDP Address field, to which packets are addressed during the GPRS communication session, is empty because the PDP context for AT 1's session has not yet been activated.

However, in 515 of FIG. 5, the Activate PDP Context Request message is further configured to indicate the application or service-specific information related to the communication session that is determined in 505 of FIG. 5. The application or service-specific information can be included within the Activate PDP Context Request message in a number of ways. For example, one or more fields within the Activate PDP Context Request message itself can be modified to include a flag that indicates the application or service-specific information.

In a more specific example, AT 1 can configure the Activate PDP Context Request message (e.g., for primary PDP context) and/or the Activate Secondary PDP Context Request (e.g., for secondary PDP context) in 515 to include special QoS configuration(s), such that the GGSN 165 and SGSN 160 can uniquely identify AT 1 based on the special configuration. Also, since the SGSN 160 will pass the QoS to the RNC at the RAN 120 in the RAB Assignment Request message (utilizing the RAB Parameter field) (e.g., see 540, below), the RNC or RAN 120 can also identify AT 1 based on the special QoS configuration, and hence allocate UTRAN resources required by the multimedia application (e.g., aggressive UTRAN DRX CYCLE, which is used to determine the paging cycle at AT 1).

In yet another example, in 515, AT 1 can select a reserved NSAPI (e.g., such as 0 to 4, which are currently prohibited and not used by standard), and include the reserved NSAPI in the Activate PDP Context Request and/or Activate Secondary PDP Context Request. As in the previous example, the GGSN 165 and SGSN 160 will read the message(s) and be able to uniquely identify the reserved NSAPI as being for a particular multimedia application (e.g., such as one that is known to require a high-level or aggressive-level of QoS). Also, since the RAB ID in the RAB Assignment Request (e.g., see 540, below) is mandated to be the same value of NSAPI, the RAN 120 can identify AT 1 based on the RAB ID.

In an alternative embodiment, special or predetermined bits can be embedded in the NSAPI information element (IE). The NSAPI IE is 8 bits, where the first 4 LSB are used to carry the NSAPI and the last 4 LSB are spare bits. Thus, in this example, AT 1 can utilize the 4 spare bits in the NSAPI IE for the SGSN 160 and GGSN 165 to identify AT 1. Since RAB ID IE=NSAPI IE per standard, the RAN 120 can identify AT 1 and can assign aggressive UTRAN DRX CYCLE to AT 1.

In yet another alternative example, an APN is a string parameter included in the Activate PDP Context Request used to select the GGSN 165. Accordingly, in 515, AT 1 can put a keyword in the APN for identifying AT 1 has having a high-QoS requirement. The GGSN 165 and SGSN 160 can receive the APN in the Activate PDP Context Request. However, the RAN 120 may not necessarily be informed of AT 1's high-QoS requirement for a particular application in this example (e.g., although the RAN 120 can be instructed to allocate an aggressive QoS setting via the RAB Assignment Request message from the SGSN in 540, below.

After configuring the Activate PDP Context Request message in 515, AT 1 sends the configured Activate PDP Request message to the SGSN 160 via the RAN 120, 520. The SGSN 160 receives the Activate PDP Context Request message and sends a Create PDP Context Request message, which also includes the application or service-specific information, to the GGSN 165, 525. The GGSN 165 receives the Create PDP Context Request message from the SGSN 160, and activates a PDP context for AT 1's communication session, 530. The activation of the PDP context in 530 includes assigning a PDP address for AT 1's communication session (e.g., an IPv6 address). The activation of 530 also includes storing, within the PDP context, the application or service-specific information for AT 1's communication session.

The GGSN 165 sends a Create PDP Context Accept message back to the SGSN 160, 535, which indicates that the Create PDP Context Request message from 525 is accepted and also conveys the PDP address and application or service-specific information for AT 1's communication session. The SGSN 160 sends a RAB assignment request for AT 1's communication session based on the PDP context to the RAN 120, 540. For example, the SGSN 160 may instruct the RAN 120 with regard to a given level of QoS resources for allocating to AT 1 during the communication session using the RAB Parameter field in the RAB Assignment Request, which contains the QoS requirements on AT 1's communication link. If the application or service-specific information indicates, to the SGSN 160 in this example, that a high-level of QoS resources are required, the SGSN 160 can instruct the RAN 120 to allocate a higher amount of QoS resources to AT 1 than would otherwise be allocated in 540. In another example, a frequency at which AT 1 wakes up can be increased if the application or service-specific information indicates, to the SGSN 160 in this example, which AT 1's communication session may benefit from a more aggressive paging cycle.

The RAN 120 receives the RAB assignment request and sends a Radio Bearer Setup message for AT 1's communication session based on the RAB parameters, 545. AT 1 receives the Radio Bearer Setup message, and sends a Radio Bearer Setup Complete message to the RAN 120, 550. The RAN 120 then sends a RAB Assignment Response message back to the SGSN 160, 555.

At this point, the SGSN 160 sends an Activate PDP Context Accept message to AT 1 via the RAN 120, 560, which indicates that the Activate PDP Context Request message from 520 is accepted and also conveys the PDP address for AT 1's communication session. After receiving the Activate PDP Context Accept message (e.g., which conveys the PDP address to be used for the session), AT 1 may begin to send and receive messages related to the established communication session, 565.

While above-described embodiments of the invention have generally been described with respect to terminology that is specific to CDMA, W-CDMA and/or EV-DO protocols, it will be appreciated that other embodiments of the invention can be modified to comply with other wireless telecommunication protocols, such as UMTS LTE and/or SAE, in an example. For example, in a UMTS implementation, the above-described call flows are still generally applicable. However, the terminology of PDP context, RNC (or RNC 122), SGSN and GGSN may instead be described as Evolved Packet System (EPS) bearer, eNodeB, Serving Gateway (GW) and packet data network (PDN) GW, respectively. Accordingly, the technical modifications to conform the CDMA implementation described above to a UMTS implementation are well within the abilities of one of ordinary skill in the art.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of allocating resources to an access terminal for a given communication session within a wireless communications system operating in accordance with a given wireless communications protocol, comprising:
determining whether one or more applications or services are supported by the access terminal for the given communication session; and
allocating resources in support of the given communication session to the access terminal based at least in part upon the determination.

2. The method of claim 1, wherein the determining step determines whether one or more applications or services are supported by the access terminal for the given communication session by evaluating a packet data protocol (PDP) context and/or the assigned radio access bearer (RAB) parameters for the given communication session.

3. The method of claim 1, wherein, if the determining step determines that a multicast service is supported by the access terminal for the given communication session, then the allocating step allocates a higher level of resources.

4. The method of claim 1, wherein the given wireless communication protocol corresponds to one of code-division multiple access (CDMA), wideband-CDMA (W-CDMA) and Universal Mobile Telecommunications System (UMTS).

5. The method of claim 1, wherein the allocating step allocates a given Quality of Service (QoS) level for the given communication session.

6. A network communication entity configured to request allocation of resources or allocate resources to an access terminal for a given communication session within a wireless communications system operating in accordance with a given wireless communications protocol, comprising:
means for determining whether one or more applications or services are supported by the access terminal for the given communication session; and
means for allocating resources in support of the given communication session to the access terminal based at least in part upon the determination.

7. The network communication entity of claim 6, wherein the means for determining determines whether one or more applications or services are supported by the access terminal for the given communication session by evaluating a packet data protocol (PDP) context and/or the assigned radio access bearer (RAB) parameters for the given communication session.

8. The network communication entity of claim 6, wherein, if the means for determining determines that a multicast service is supported by the access terminal for the given communication session, then the means for allocating allocates a higher level of resources.

9. The network communication entity of claim 6, wherein the given wireless communication protocol corresponds to one of code-division multiple access (CDMA), wideband-CDMA (W-CDMA) and Universal Mobile Telecommunications System (UMTS).

10. The network communication entity of claim 6, wherein the means for allocating allocates a given Quality of Service (QoS) level for the given communication session.

11. The network communication entity of claim 6, wherein the network communication entity corresponds to one of an access network, a Serving General Packet Radio Services (GPRS) Support Node (SGSN) and/or a Gateway GPRS Support Node (GGSN).

12. A network communication entity configured to request allocation of resources or allocate resources to an access terminal for a given communication session within a wireless communications system operating in accordance with a given wireless communications protocol, comprising:
logic configured to determine whether one or more applications or services are supported by the access terminal for the given communication session; and
logic configured to allocate resources in support of the given communication session to the access terminal based at least in part upon the determination.

13. The network communication entity of claim 12, wherein the logic configured to determine determines whether one or more applications or services are supported by the access terminal for the given communication session by evaluating a packet data protocol (PDP) context and/or the assigned radio access bearer (RAB) parameters for the given communication session.

14. The network communication entity of claim 12, wherein, if the logic configured to determine determines that a multicast service is supported by the access terminal for the given communication session, then the logic configured to allocate allocates a higher level of resources.

15. The network communication entity of claim 12, wherein the given wireless communication protocol corresponds to one of code-division multiple access (CDMA), wideband-CDMA (W-CDMA) and Universal Mobile Telecommunications System (UMTS).

16. The network communication entity of claim 12, wherein the logic configured to allocate allocates a given Quality of Service (QoS) level for the given communication session.

17. The network communication entity of claim 12, wherein the network communication entity corresponds to one of an access network, a Serving General Packet Radio Services (GPRS) Support Node (SGSN) and/or a Gateway GPRS Support Node (GGSN).

18. A non-transitory computer-readable medium comprising instructions, which, when executed by a network communication entity configured to request allocation of resources or allocate resources to an access terminal for a given communication session within a wireless communications system operating in accordance with a given wireless communications protocol, cause the network communication entity to perform operations, the instructions comprising:
program code to determine whether one or more applications or services are supported by the access terminal for the given communication session; and
program code to allocate resources in support of the given communication session to the access terminal based at least in part upon the determination.

19. The non-transitory computer-readable medium of claim 18, wherein the program code to determine determines whether one or more applications or services are supported by the access terminal for the given communication session by evaluating a packet data protocol (PDP) context and/or the assigned radio access bearer (RAB) parameters for the given communication session.

20. The non-transitory computer-readable medium of claim 18, wherein, if the program code to determine determines that a multicast service is supported by the access terminal for the given communication session, then the program code to allocate allocates a higher level of resources.

21. The non-transitory computer-readable medium of claim 18, wherein the given wireless communication protocol corresponds to one of code-division multiple access (CDMA), wideband-CDMA (W-CDMA) and Universal Mobile Telecommunications System (UMTS).

22. The non-transitory computer-readable medium of claim 18, wherein the program code to allocate allocates a given Quality of Service (QoS) level for the given communication session.

23. The non-transitory computer-readable medium of claim 18, wherein the network communication entity corresponds to one of an access network, a Serving General Packet Radio Services (GPRS) Support Node (SGSN) and/or a Gateway GPRS Support Node (GGSN).
